(19) United States
(12) Patent Application Publication
(10) Pub. No.: US 2003/0161385 A1
(43) Pub. Date: Aug. 28, 2003

(54) Linear interference suppression detection

(76) Inventors: Chao-Ming Chang, Hsinchu (TW); Kwang-Cheng Chen, Palo Alto, CA (US)

Correspondence Address: Donald R. Studebaker, Esquire, NIXON PEABODY LLP, 8180 Greensboro Drive, Suite 800, McLean, VA, 22102, US

(21) Appl. No.: 09/760,779

(22) Filed: Jan. 17, 2001

(51) Int. Cl. H04K 1/00; H04B 15/00; H04L 27/30

(52) U.S. Cl. 375/131

(57) ABSTRACT

A method, and a system of mitigating interference effects under a communication environment including a first spread spectrum (SS) transmission scheme and a second spread spectrum (SS) transmission scheme in the same frequency band are proposed in this present invention. Firstly, responsive to a received signal, output number of signal of the first SS transmission scheme and the second SS transmission scheme. Secondly, retrieve the timing, phase and amplitude information of signals of the first SS transmission scheme in the received signal, and the timing, phase and amplitude information of signals of the second SS transmission scheme. Generate a plurality of linearly-modulated signals based on a predetermined manner, correlate the received signal based on the plurality of linearly-modulated signals to generate a correlated outputs. Finally, selectively produce an estimated information sequence carried by the signals of the first SS transmission scheme and the signals of the second SS transmission scheme based on the correlated outputs in another predetermined manner.

Such a method and a system not only extend the ability of conventional linear multi-user detection to the FH-CDMA (frequency hopping code division multiple access) and the DS-FH-CDMA (direct sequence and frequency hopping code division multiple access) multi-user communications systems, but also remove the limitations of the conventional linear multi-user detection on linearly modulated signals. In addition, the multi-user synchronizers proposed in this invention, which estimate the received timings, phases, and amplitudes of the interfering and the desired spread spectrum signals with feasible complexity, further complete the interference suppression communications system. This invention is applicable to various environments. For example: the source of DSSS signals could be derived from the IEEE 802.11b devices or perhaps the IEEE 802.15.3 devices; the source of FHSS signals could be derived from the IEEE 802.15.1 (Bluetooth) devices or the HomeRF devices. Moreover, this invention is not limited to the wireless communications as it is equally applicable to the optical communications systems (e.g. the HFC (hybrid-fiber-coax) networks) and the wired communications systems.

### FIELD OF INVENTION

The present invention generally relates to communication systems, and more particularly, to Spread Spectrum communication systems having interference mitigation capability.

### BACKGROUND OF INVENTION

Driven by the great amount of interests in developing the wireless personal area network (WPAN), the IEEE 802.15 working group was formed working on the standard that provides low-cost, low-power consumption and short-distance (around 10 meters) transmission. To ease the development, the IEEE 802.15 working group accepted the suggestion of Bluetooth Special Interest Group to incorporate Bluetooth technology into the 802.15 standard, known as IEEE 802.15.1. However, the usage of Bluetooth technology on the unlicensed 2.4 GHz band which is also the transmission band for many communications systems (e.g. IEEE WLAN 802.11b, and HomeRF) suggests the problem of mutual interference from these incompatible protocols.

To seek a solution, the IEEE 802.15.2 task group was formed to work on the coexistence issue between these protocols. Especially, the coexistence between IEEE WLAN 802.11b and Bluetooth is of primary importance. As the 802.11b employed the direct sequence spread spectrum (DSSS) transmission technology while the Bluetooth employed frequency hopping spread spectrum (FHSS) technology, we are dealing the problem of the detection of a DSSS or FHSS signal interfered by multiple DSSS and FHSS interference.

A great amount of work was done on the interference suppression for the DSSS signal by its inherited ability to suppress the interference [1, 2, 3]. On the other hand, the FHSS signal mitigates the interference by employing proper adaptive frequency hopping mechanisms [4]. Both categories of these known interference suppression techniques utilize the interference suppression nature of spread spectrum communications by ignoring the possible information from the interference.

Since 1986 [5], a new series of designs known as multiuser detectors were proposed to mitigate the multiple access interference (MAI) derived from the simultaneously received DSSS signals in the same frequency band. Among these known multiuser detectors, the linear-complexity multi-user detectors [6, 7, 8] designed according to different design criteria do effectively mitigate the interference. However, these designs were designed to suppress the DSSS interference only.

In the detection of a direct sequence spread spectrum (DSSS) or frequency hopping spread spectrum (FHSS) signal interfered by other DSSS and FHSS signals, the optimal detection based on the maximum a posteriori probability (MAP) criterion could be derived similarly as in multiuser detection [5]. Despite the optimal performance such an interference suppression detector stands, its dramatically increased complexity to the number of interference sources suggests the need of a linear-complexity interference suppression detector which effectively suppresses the interference. Previous development on linear multiuser detection is subjected to the linearly modulated signals, such as the M-ary phase shift keying (MPSK) modulation. In the present invention, interference suppression detector to non-linear modulated signals is also proposed. Particularly, to meet the specifications in IEEE 802.22b and Bluetooth, the linear-complexity interference suppression detectors are developed considering both the presence of DSSS signals modulated by BPSK (or QPSK) and the FHSS signals modulated by Gaussian frequency shift keying (GFSK).

### SUMMARY OF INVENTION

Previous technique on multi-user detection was used to mitigate the interference from other DSSS signals. The present invention extends its ability to mitigate the interference from FHSS signals and/or DSSS signals. In addition, the known linear multi-user detection is limited to the linearly modulated signals, and the present invention extends its ability to even the non-linearly modulated signals.

In one aspect of the present invention, a method and a system of mitigating interference effects under a communication environment including a first spread spectrum (SS) transmission scheme and a second spread spectrum (SS) transmission scheme in the same frequency band is proposed. The method comprises the following steps: (1) responsive to received signal, output number of signals of the first SS transmission scheme and the second SS transmission scheme; (2.a) obtain the timing information of signals of the first SS transmission scheme in the received signal when one signal of the first SS transmission scheme is detected before a predetermined time t1; (2.b) obtain the timing information of signals of the second SS transmission scheme in the received signal using the timing information of signals of the first SS transmission scheme; (3) generate a plurality of linearly-modulated signals, (4) correlate the received signal based on the plurality of linearly-modulated signals to generate correlated outputs; and (5) selectively produce an estimated information sequence carried by the signals of the first and the second SS transmission scheme based on the correlated outputs.

Such a method and a system not only extend the ability of conventional linear multi-user detection to the FH-CDMA (frequency hopping code division multiple access) and the DS-FH-CDMA (direct sequence and frequency hopping code division multiple access) multi-user communications systems, but also remove the limitations of the conventional linear multi-user detection on linearly modulated signals. In addition, the multi-user synchronizers proposed in this invention, which estimate the received timings, phases, and amplitudes of the interfering and the desired spread spectrum signals with feasible complexity, further complete the interference suppression communications system.

This invention is applicable to various environments. For instance, it can be used to suppress the hostile and/or accidental sources of interference. Moreover, it can be used to mitigate the interference transmitted from other incompatible wireless communications systems which simultaneously utilize the same frequency band in a legal manner. For example, the IEEE 802.11b, the IEEE 802.15, HomeRF, and etc aim the unlicensed ISM (industrial-science-medical) band as their target band taking rules from FCC (federal communications commission). And the coexistence issue on how to mitigate the mutual interference from these incompatible but legal protocols becomes the most challenging task.

Since the source of DSSS signals could be derived from the IEEE 802.11b devices or perhaps the IEEE 802.15.3 devices; the source of FHSS signals could be derived from the IEEE 802.15.1 (Bluetooth) devices or the HomeRF devices, it can be seen easily the application of this invention to the coexistence issues of these protocols/specs.

This invention is not limited to the wireless communications as it is equally applicable to the optical communications systems (e.g. the HFC (hybrid-fiber-coax) networks) and the wired communications systems to suppress the interference.

In fact, the ability of the proposed linear interference suppression detection is not limited to the DSSS and FHSS signals. As long as we could retrieve the information from the interference, the proposed detection can be equally applied to suppress the interference in any communications system.

### BRIEF DESCRIPTION OF THE DRAWINGS

The present invention will become fully understood from the detailed description given herein below with the accompanying drawings, given by way of illustration only and thus not intended to limit the present invention.

FIG. 1 illustrates the definition of the term “synchronous” and “asynchronous”.

FIG. 2 illustrates the block diagram of present invention.

FIG. 3 illustrates the flowchart of synchronization scheme.

FIG. 4 illustrates an exemplar embodiment of obtaining phase and amplitude information.

FIG. 5 illustrates an exemplar embodiment of the synchronization scheme.

FIG. 6 illustrates another exemplar embodiment of the synchronization scheme.

FIG. 7 illustrates the non-coherent timing estimation mechanism.

FIG. 8 illustrates an exemplar embodiment of the non-coherent timing estimation.

FIG. 9 illustrates the detailed block diagram of the synchronization block.

FIG. 10 illustrates the detailed block diagram of the detection block.

FIG. 11 illustrates the flowchart of the construction block.

FIG. 12 illustrates the mechanism of the construction block.

FIG. 13 illustrates the flowchart of the detection block.

FIG. 14 illustrates the flowchart of the detection block.

FIG. 15 illustrates the detailed block diagram of the construction block.

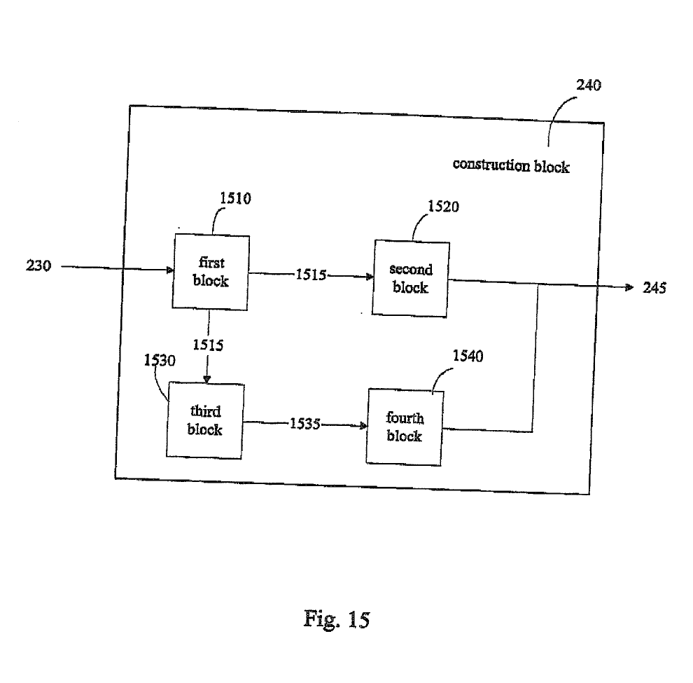

FIG. 16 illustrates the flowchart of the detection block.

### DETAILED DESCRIPTION OF PRESENT INVENTION

One aspect of the present invention is used to mitigate interference effects under a communication environment including a first spread spectrum (SS) transmission scheme and a second spread spectrum (SS) transmission scheme in the same frequency band.

To describe the invention clearly, a number of definitions of terms used herein are given as follows.

The term “spread spectrum” used herein refers to a variety of radio transmission methods that continuously change frequencies or signal patterns. Direct sequence spread spectrum (DSSS), which is used in CDMA, multiplies the data bits by a very fast pseudo-random bit pattern (PN sequence) that “spreads” the data into a large coded stream that takes the full bandwidth of the channel

Frequency hopping spread spectrum (FHSS) continuously changes the center frequency of a conventional carrier several times per second according to a pseudo-random set of channels, while chirp spread spectrum changes the carrier frequency.

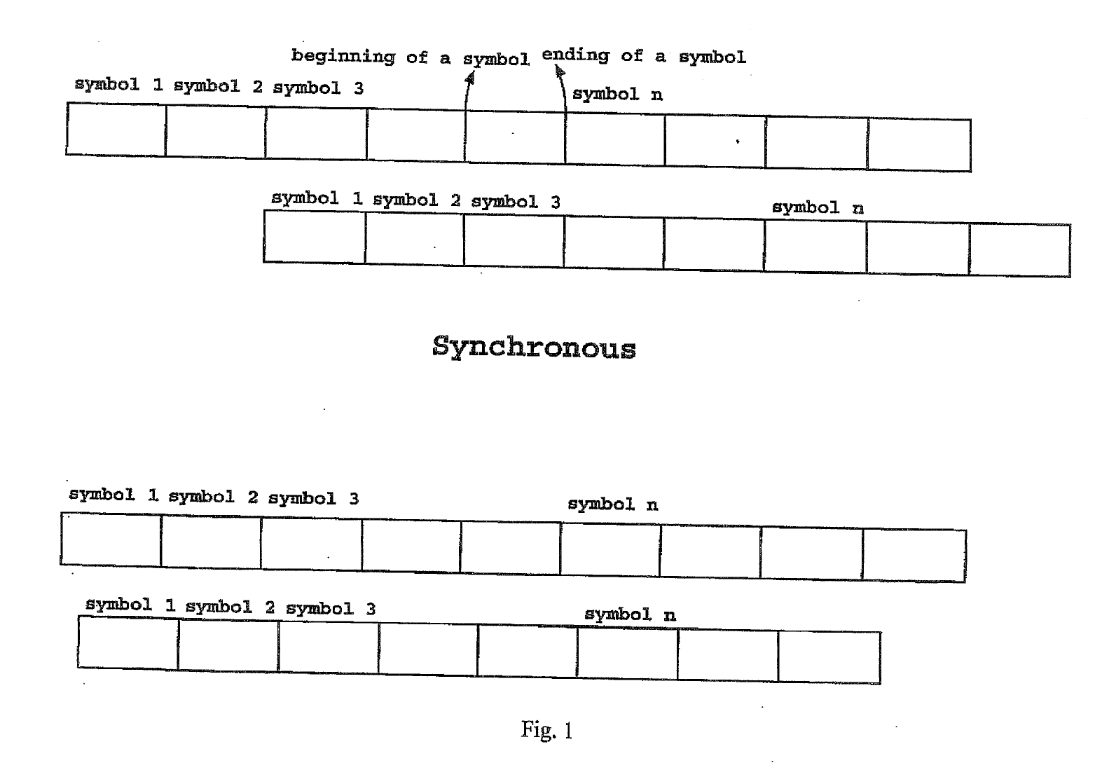

The term “synchronous” and “asynchronous” used herein refers to a set of overlapped signals, wherein any two of the signals within the signals set satisfy the condition that the symbols of these two signals are aligned such that the beginning of some symbol within one signal is aligned with the beginning or ending of some symbol within the other signal, and a set of overlapped signals are asynchronous provided they are not synchronous. Please refer to FIG. 1 for a better understanding of the definition.

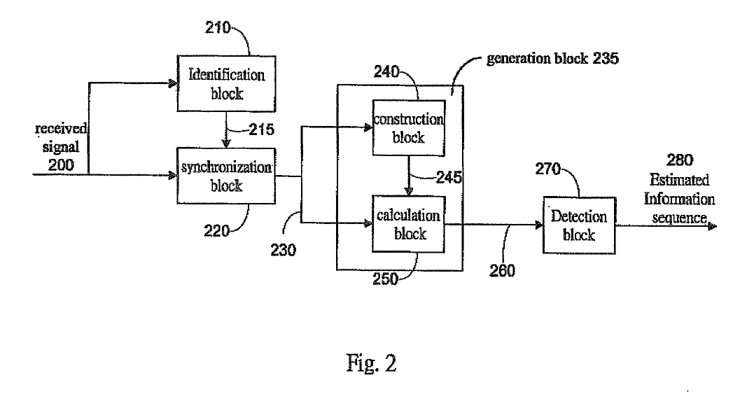

Please refer to FIG. 2 for a block diagram illustrates the present invention, a received signal 200 is detected and sent to the identification block 210 and synchronization block 220, wherein the identification block 210 outputs number 215 of signals of the first and the second SS transmission scheme.

Preferably, the first SS transmission scheme is Direct Sequence Spread Spectrum (DSSS), and the identification block 210 also outputs the employed spreading waveform 215 of DSSS signals in the received signal 200. The second SS transmission scheme is Frequency Hopping Spread Spectrum (FHSS), and the identification block also outputs the hopping frequencies of FHSS signals in the received signal 200.

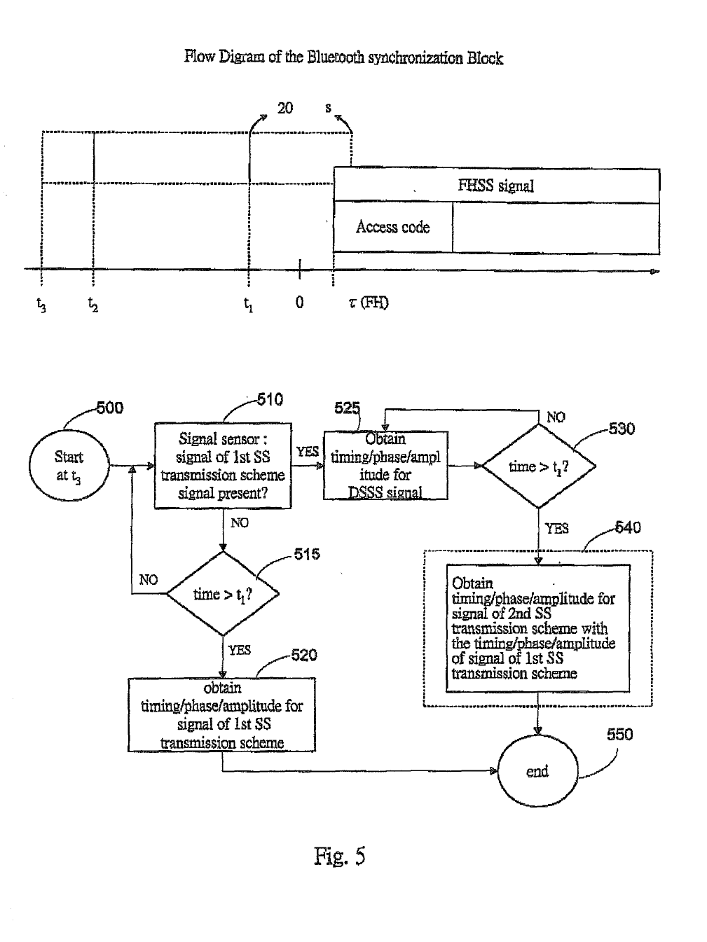

In FIG. 2, the synchronization block 220 obtains a timing information 230 of signals of the first SS transmission scheme and the second SS transmission scheme. Please refer to FIG. 5 for details of the synchronization block. When one signal of the first SS transmission scheme is detected 510 before a predetermined time t1 530. Obtain the timing information 525 of signals of the first SS transmission scheme in the received signal. And obtain the timing information 540 of signals of the second SS transmission scheme in the received signal using the timing information 525 of signals of the first transmission scheme.

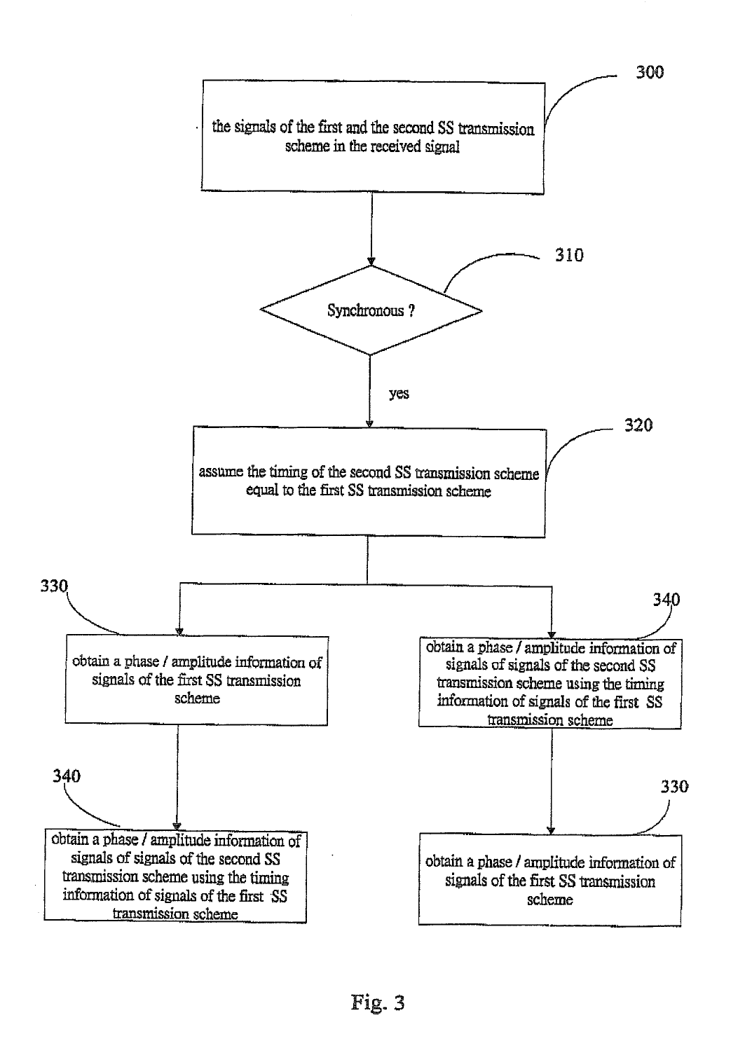

In FIG. 3, if the signals of the first and the second SS transmission scheme 300 are synchronous 310, assuming the timing of signals of the second SS transmission scheme in the received signal equal to the timing of signals of the first SS transmission scheme 320. And the phase and amplitude information can also be obtained. In step 330, obtain a phase information of signals of the first SS transmission scheme transmission scheme in the received signal. In step 340, obtain a phase of signals of the second SS transmission scheme in the received signal using the timing information of signals of the first SS transmission scheme. Whereas in step 330, obtain a amplitude information of signals of the first SS transmission scheme in the received signal; and in step 340, obtain an amplitude information of signals of the second SS transmission scheme in the received signal using the timing information of signals of the first SS transmission scheme.

Please note that the step 340 and 330 is interchangeable, which means we can perform the step 340 first then 330, or vice versa.

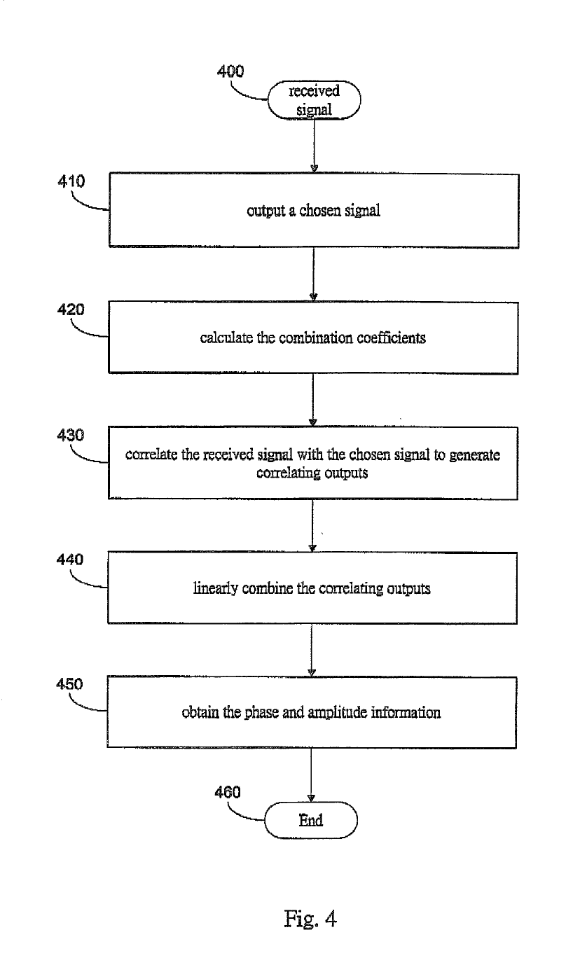

In one exemplar aspect of the present invention, the phase and amplitude information can be obtained as shown in FIG. 4. In the first and the second SS transmission scheme 400, selectively outputting a chosen signal with a time delay 410, where the time delay is determined by the timing information of the first and the second SS transmission scheme. Calculate the combination coefficients based on the timing information of the first and the second SS transmission scheme 420. Then correlate the received signal with the chosen signal 430 to produce correlating outputs. In step 440, linearly combine the correlating outputs using the combination coefficients. And finally obtain a phase and amplitude of the chosen signal using the linear combination output 450.

Please refer to the FIG. 5 for the asynchronous case, when there is no signal of the first SS transmission scheme is detected 510 after the predetermined time t1 515, obtain the timing information of signals of the second SS transmission scheme in the received signal 520. Furthermore, a phase information of signals of the second SS transmission scheme in the received signal 520 when there is no signal of the first SS transmission scheme is detected 510 after the predetermined time t1 515. And in the meantime, we can obtain an amplitude information of signals of the second SS transmission scheme in the received signal 520 when there is no signal of the first SS transmission scheme is detected 510 after the predetermined time t1 515.

Also in FIG. 5, as mentioned before, the phase and amplitude information of the first and the second SS transmission scheme can be individually, or jointly obtained using the following steps: Obtain a phase/amplitude information of signals of the first SS transmission scheme in the received signal 525 when one signal of the first SS transmission scheme is detected 510 before a predetermined time t1 530. Obtain a phase/amplitude information 540 of signals of the second SS transmission scheme in the received signal using the timing information 525 of signals of the first SS transmission scheme.

In the asynchronous case, the present invention utilize the asynchronous nature to possibly estimate the received timing, phase and amplitude of the first SS transmission scheme before the reception of the second SS transmission scheme.

Such an synchronization (timing, phase and amplitude estimation) mechanism ignores the possibility that the signal of the first SS transmission scheme is received after time t1, thus its performance might be degraded.

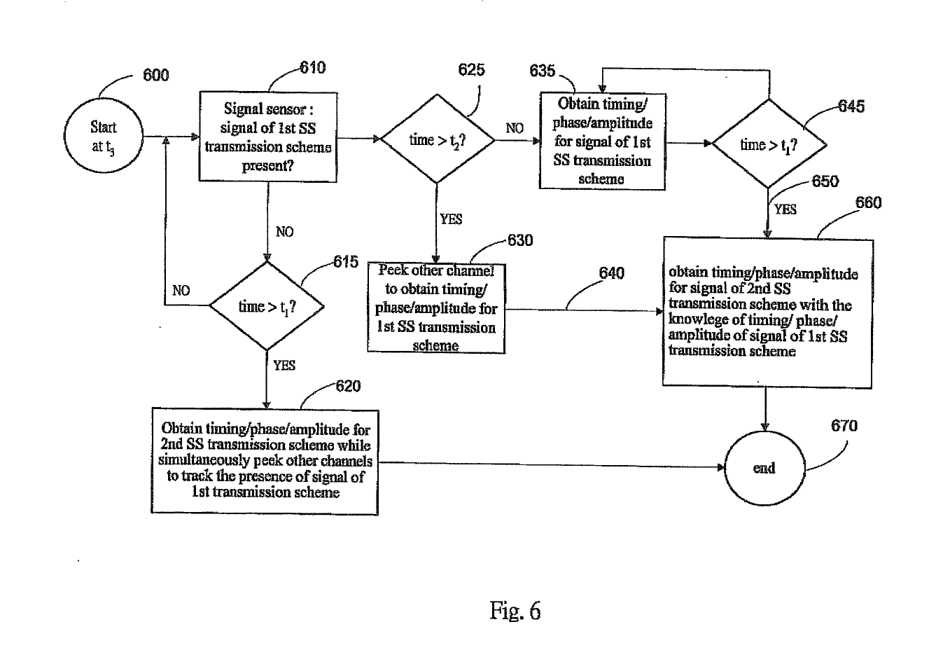

Therefore, another exemplar aspect of the present invention is illustrated in FIG. 6. In FIG. 6, when one signal of the first SS transmission scheme in the received signal is detected 610 after a predetermined time t2 625, peeking other frequency bands 630 to obtain a first timing information 640 of signals of the first SS transmission scheme in the received signal. Here the term “other frequency bands” refers to frequency bands that contain the signals of the first SS transmission scheme. When one signal of the first SS transmission scheme in the received signal is detected before the predetermined time t2 625, in step 630, obtain a second timing information 650 of signals of the first SS transmission scheme in the received signal. Then obtain a timing information 660 of signals of the second SS transmission scheme in the received signal using the first 640 and the second timing information 650 of the signals of the first SS transmission scheme.

The flow diagram in FIG. 6 can be used to obtain the phase and amplitude information of signals of the first and the second SS transmission scheme. When one signal of the first SS transmission scheme in the received signal is detected after a predetermined time t2 625, peeking other frequency bands 630 to obtain a first timing and phase 640 information of signals of the first SS transmission scheme in the received signal.

When one signal of the first SS transmission scheme in the received signal is detected before the predetermined time t2 625, in step 635 obtain a second timing and phase information 650 of signals of the first SS transmission scheme in the received signal. Then obtain the timing and phase information of signals of the second SS transmission scheme 660 in the received signal using the first 640 and the second timing and phase information 650 of the signals of the first SS transmission scheme.

While the amplitude information of signals of the first and the second SS transmission scheme can be obtained in the same way. The method mentioned above can jointly estimate the timing, phase and amplitude information of signals of the first and the second SS transmission scheme. In FIG. 6, when one signals of the first SS transmission scheme in the received signal is detected after a predetermined time t2 625, peeking other frequency bands 630 to obtain a first timing, phase and amplitude information 640 of signals of the first SS transmission scheme in the received signal. When one signal of the first SS transmission scheme in the received signal is detected before the predetermined time t2 625, in step 635, obtaining a second timing, phase and amplitude information 650 of signals of the first SS transmission scheme in the received signal. By using the first 640 and the second timing, phase and amplitude information 650 of the signals of the first SS transmission scheme, 660 obtain the timing phase, and amplitude information of signals of the second SS transmission scheme in the received signal.

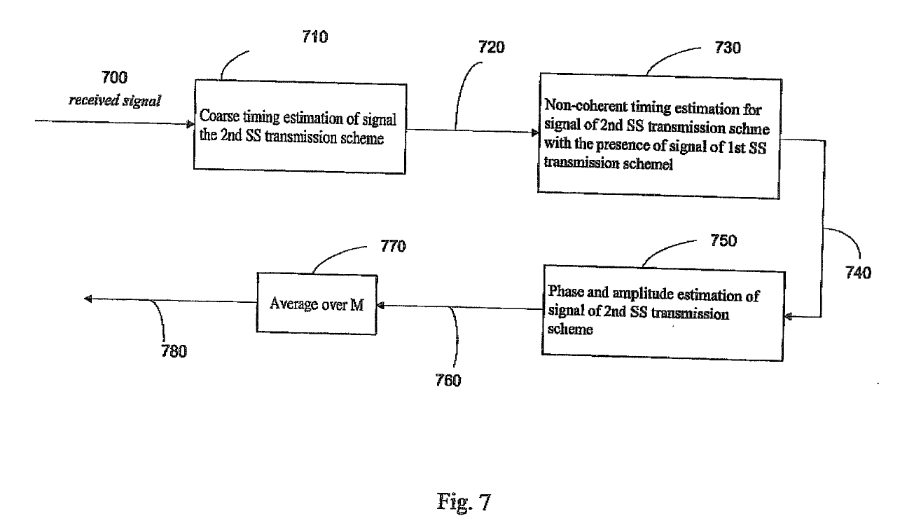

FIG. 7 is a detailed description of the step 660 of obtaining the timing information of signals of the second SS transmission scheme in FIG. 6. In the past, joint estimation on the received timing, phase and amplitude is of great complexity. Here, the joint estimation can be simplified by implementing the non-coherent timing estimation, which is shown in the flow diagram of FIG. 7. The steps are described as followed: Perform the following steps for M times: (1) in step 710, perform the coarse timing estimation 720 of signals of the second SS transmission scheme in the received signal to obtain assume an initial received timing estimate τ. (2) In step 730, calculate an intermediate timing 740 of signals of the second SS transmission scheme in the received signal using the timing information of signals of the first SS transmission scheme in the received signal and the initial received timing estimation τ. (3) In step 750, obtain an intermediate phase, amplitude 760 of signals of the second SS transmission scheme in the received signal based on the intermediate timing 740. After repeat the above steps for M times, obtain the timing, phase and amplitude information 780 of signals of the second SS transmission scheme by averaging the intermediate timings, phases and amplitudes obtained by M 770. Such a mechanism can be used solely to estimate the timing, or jointly estimate the timing, phase and amplitude.

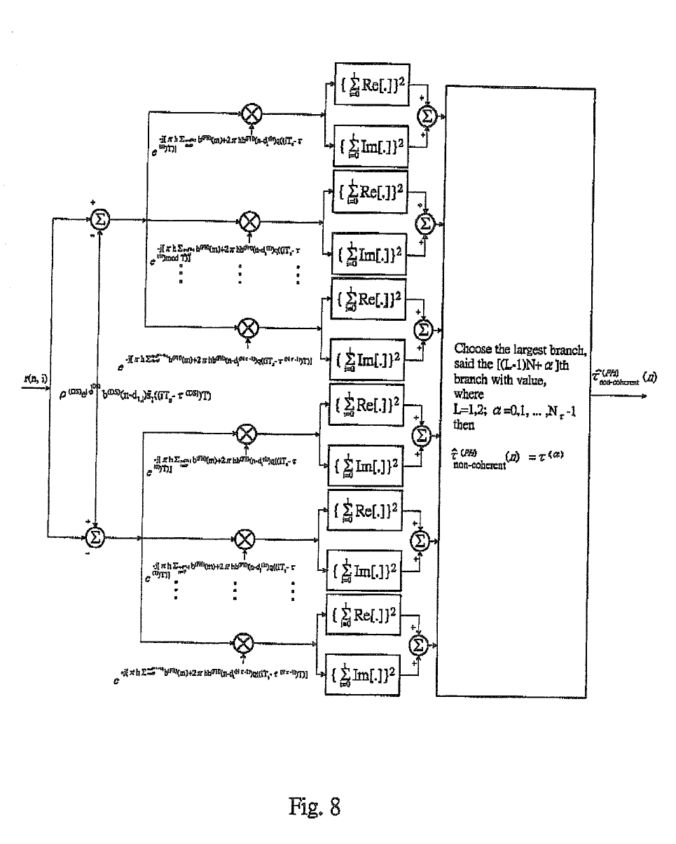

In an exemplar embodiment illustrated in FIG. 8, the first transmission scheme refers to DSSS, and the second transmission scheme refers to FHSS, the received signal is denoted as r(n, I), τ^{(DS)} and τ^{(FH)} represent the timing of DSSS and FHSS signal respectively. The flowchart depicts the non-coherent timing estimation of the FHSS signal interfered by a DSSS signal. The resulted τ^{(FH)}_{non-coherent}(n) is the intermediate timing 740.

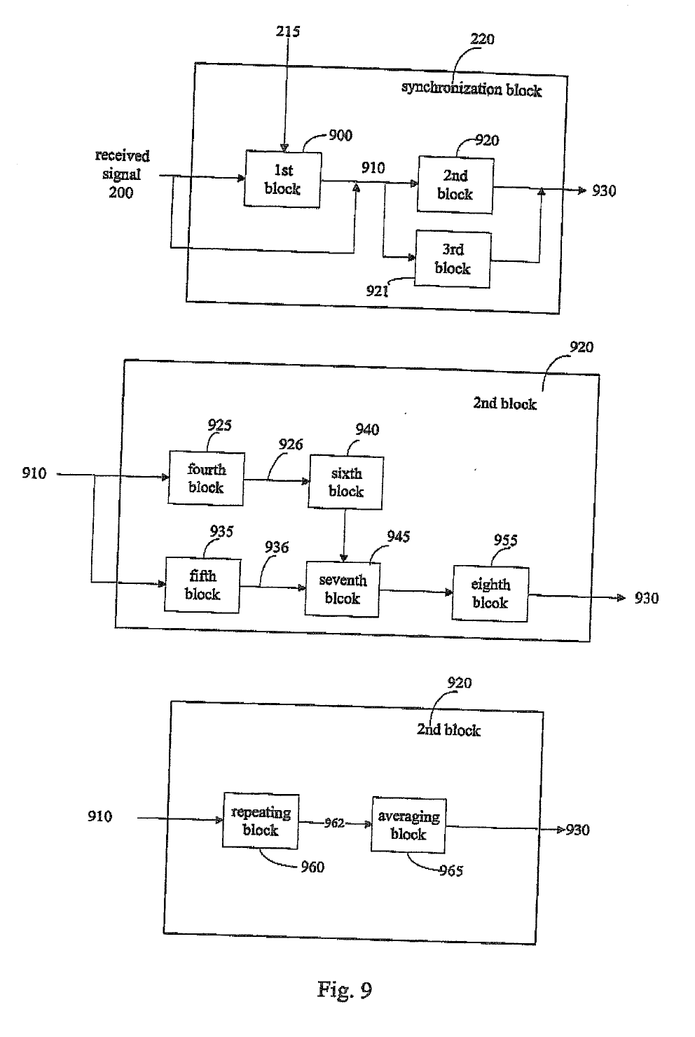

FIG. 9 depicts the detailed block diagram of the synchronization block 220 in FIG. 2. The synchronization block 220 is used to obtain a timing information of signals of the first SS transmission scheme and the second SS transmission scheme, which comprises a first block 900 for selectively obtaining the timing information 910 of signals of the first SS transmission scheme in the received signal 200; a second block 920 for selectively obtaining the timing information of signals of the second SS transmission scheme in the received signal using the timing information 910 of signals of the first SS transmission scheme; a third block 921 for as assuming the timing 930 of signals of the second SS transmission scheme in the received signal equal to the timing 910 of signals of the first SS transmission scheme when signals of the first and the second SS transmission scheme are synchronous.

The first block 900 can also obtain a phase information 910 of signals of the first SS transmission scheme transmission scheme in the received signal 200; and the second block 920 can also obtain a phase 920 of signals of the second SS transmission scheme in the received signal 200 using the timing information 910 of signals of the first SS transmission scheme. The amplitude of the first and the second SS transmission scheme, or the joint timing, phase and amplitude estimation can be obtained in the same manner.

In FIG. 9, the synchronization block further comprises a fourth block 925 for selectively outputting a chosen signal 926 with a time delay in the first and the second SS transmission scheme, a fifth block 935 for calculating combination coefficients 936 based on the timing information of the first and the second SS transmission scheme; a sixth block for correlating the received signal 200 with the chosen signal 926 to produce correlating outputs 940; a seventh block 945 for linearly combining the correlating outputs 940 using the combination coefficients 936 to produce linear combination outputs 946; an eighth block 955 for obtaining a phase and amplitude 930 of the chosen signal 926 using the linear combination output 946.

In the synchronization block 220, the second block 920 further obtains the timing information of signals of the second SS transmission scheme in the received signal when there is no signal of the first SS transmission scheme is detected after the predetermined time t1. The phase and amplitude information can also be obtained in the same way.

And the first block 900 in the synchronization block 220 further selectively peeking other frequency bands to obtain a first timing information 910 of signals of the first SS transmission scheme in the received signal; and further selectively obtains a second timing information 910 of signals of the first SS transmission scheme in the received signal;

The second block 920 further selectively obtains a timing information of signals of the second SS transmission scheme in the received signal using the first and the second timing information 910 of the signals of the first SS transmission scheme. And we can get the phase and amplitude information of the first and the second SS transmission scheme as well.

In FIG. 9, the synchronization block further comprises a repeating block 960 for performing the following steps for M times: (1) assuming an initial received timing estimate τ of signals of the second SS transmission scheme in the received signal; (2) calculating an intermediate timing of signals of the second SS transmission scheme in the received signal using the timing information of signals of the first SS transmission scheme in the received signal and the initial received timing estimation τ; (3) obtaining an intermediate phase, amplitude 962 of signals of the second SS transmission scheme in the received signal based on the intermediate timing;

The synchronization block 920 further comprises an averaging block for obtaining the timing, phase and amplitude information 930 of signals of the second SS transmission scheme by averaging the intermediate timings, phases and amplitudes 962 obtained in the repeating means by M.

Furthermore, in FIG. 2, the predetermined block 235 generate a plurality of linearly-modulated signals 260, and the detection block 270 correlates the received signal 200 based on the plurality of linearly-modulated signals 260 to generate correlated outputs; based on the correlated outputs, the detection block 270 selectively produces an estimated information sequence 280 carried by the signals of the first and the second SS transmission scheme.

In another exemplar aspect of the invention, wherein a system for mitigating interference effects under a communication environment including a Direct Sequence Spread Spectrum (DSSS) signal and a Frequency Hopping Spread Spectrum (FHSS) signal in the same frequency band, please refer to the block diagram in FIG. 2. The system comprises an identification block 210 for outputting number and spreading waveform 215 of the DSSS signals, and outputting number and hopping frequencies 215 of the FHSS signals; a synchronization block 220 for obtaining timings of the DSSS signals and the FHSS signals; a construction block 240 for selectively outputting a plurality of linearly-modulated signals 245; a calculation block 250 for calculating combination coefficients using the timing information of the DSSS signal and the FHSS signal.

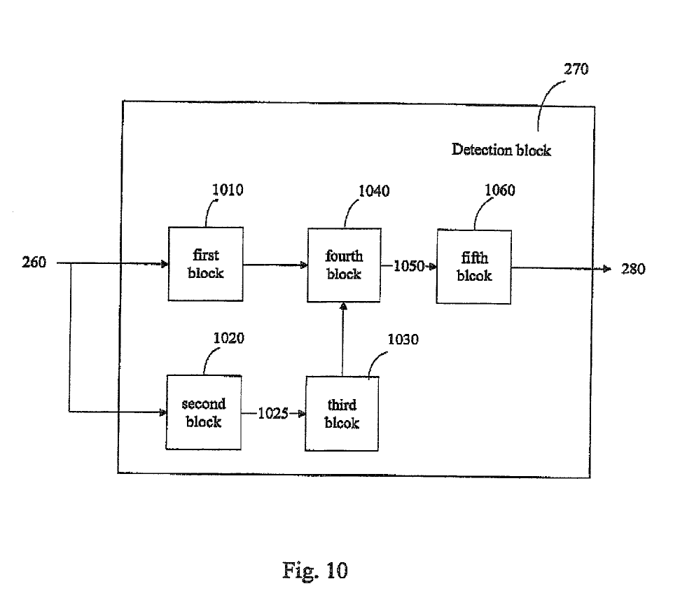

Furthermore, in FIG. 2, the detection block 270 for correlating the received signal, further comprises (illustrated in FIG. 10): a first block 1010 for correlating the received signal with DSSS signal; a second block 1020 for using a FHSS signal in the plurality of linearly-modulated to produce a FHSS signal 1025 with time delay, wherein the time delay is determined by received timings of the FHSS signals.

And the detection block 270 also includes a third block 1030 for correlating the received signal with the FHSS signal with time-delay; a fourth block 1040 for generating linear combination outputs 1050; a fifth block 1060 for selectively producing an estimated information sequence 280 carried by the DSSS signals and the FHSS signals based on the linear combination outputs 1050.

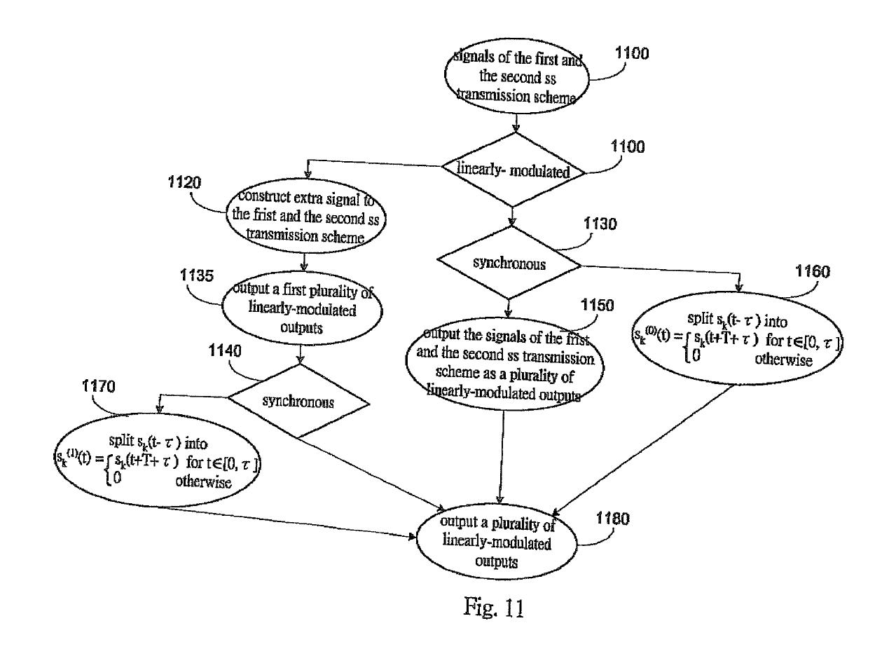

FIG. 11 shows the detailed flowchart of the exemplar aspect of the present invention. Please note that the first SS transmission scheme and the second SS transmission scheme refer to DSSS and FHSS signals respectively. At first, responsive to a received signal, output number and spreading waveform of the DSSS signals, and number and hopping frequencies of the FHSS signals; then obtains timings of the DSSS signals and the FHSS signals;

If the DSSS signals and the FHSS signals are linearly-modulated 1100, outputs a plurality of linearly-modulated signals.

Preferrably, if the DSSS and FHSS signals are asynchronous 1130, performing the following equation 1160:

$$s p l i t t i n g {S}_{k} ( t - τ ) i n t o {S}_{k} ( t - τ ) i n t o S {k}^{( 0 )} ( t ) = \{ \begin{matrix} = S k ( t + T - t ) , f o r t in [ 0 , t ] \\ 0 , o t h e r w i s e\end{matrix} \\ S {k}^{( 1 )} ( t ) = \{ \begin{matrix} = S k ( t - t ) , f o r t in [ t , T ] \\ 0 , o t h e r w i s e\end{matrix}$$

wherein Sₖ(t) is a FHSS or DSSS signal having a duration of T; then outputs a plurality of linearly-modulated signals 1180 based on the above equation 1160.

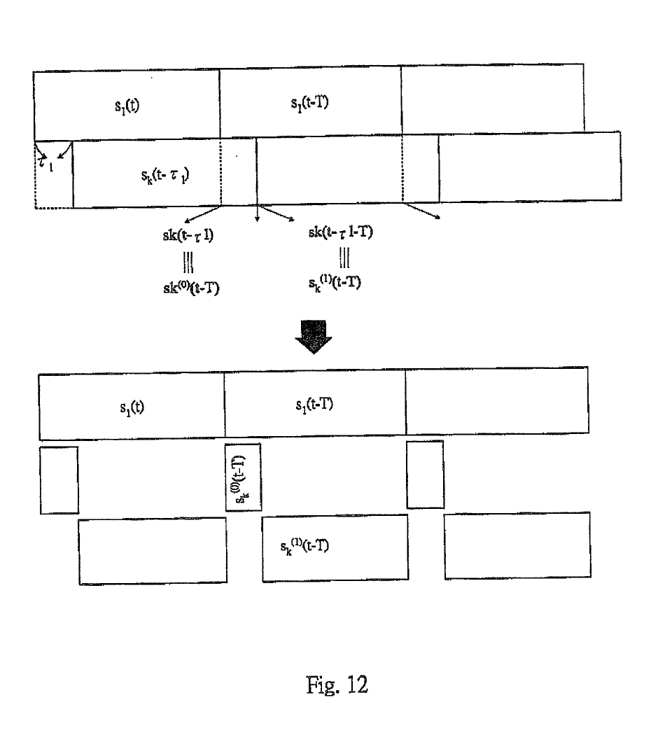

If the DSSS and the FHSS signals are synchronous 1130, step 1150 outputs the DSSS signals and the FHSS signals as a plurality of linearly-modulated signals 1180; correlating the received signal based on the following steps. FIG. 12 depicts the rationale of how to split the asynchronous signal into synchronous signals.

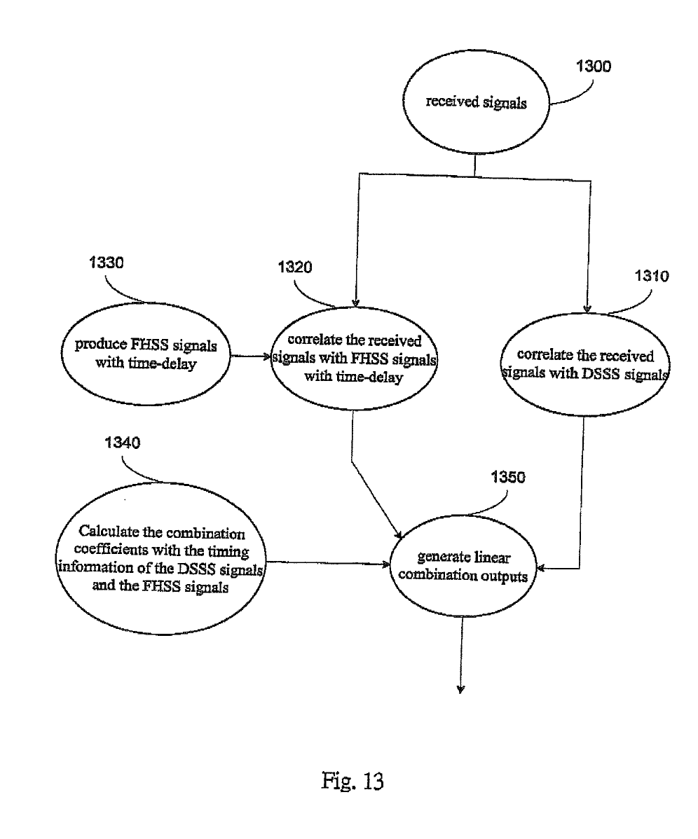

Furthermore, in FIG. 13, calculate a combination coefficient 1310 using the timing information of the FHSS signals and the DSSS signals; correlate the received signal with DSSS signal 1320; use a FHSS signal in the plurality of linearly-modulated to produce a FHSS signal with time delay 1330, wherein the time delay is determined by received timings of the FHSS signals; correlate the received signal with the FHSS signal with time-delay 1340; generate linear combination outputs 1350 based on the output of step 1310-1320 and 1340; and selectively produce an estimated information sequence carried by the DSSS signals and the FHSS signals based an the linear combination outputs 1350.

The above method can also be applied to the communication environment including a Frequency Hopping Spread Spectrum (FHSS) signal and a Frequency Hopping Spread Spectrum (FHSS) signal in the same frequency band with little modification. In this communication environment, the system comprises an identification block 210 for outputting number and hopping frequencies 215 of the FHSS signals; a synchronization block 220 for obtaining timings of the FHSS signals; a construction block 240 for selectively outputting a plurality of linearly-modulated signals 245; a calculation block 250 for calculating combination coefficient using the timing information of the FHSS signal.

And in FIG. 2, the detection block 270 for correlating the received signal further comprises (illustrated in FIG. 10); a second block 1020 for using a FHSS signal in the plurality of linearly-modulated to produce a FHSS signal 1025 with time delay, wherein the time delay is determined by received timings of the FHSS signals.

And the detection block 270 also includes a third block 1030 for correlating the received signal with the FHSS signal with time-delay; a fourth block 1040 for generating linear combination outputs 1050; a fifth block 1060 for selectively producing an estimated information sequence 280 carried by FHSS signals based on the linear combination outputs 1050.

FIG. 11 shows the detailed flowchart of the exemplar aspect of the present invention. Please note that the first SS transmission scheme and the second SS transmission scheme both refer to FHSS signals. At first responsive to a received signal, output number and hopping frequencies of the FHSS signals; then obtains timings of the FHSS signals;

If the FHSS signals are linearly-modulated 1100, outputs a plurality of linearly-modulated signals.

Preferrably, if the FHSS signals are asynchronous 1130, performing the following equation 1160:

$$s p l i t t i n g {S}_{k} ( t - τ ) i n t o {S}_{k} ( t - τ ) i n t o S {k}^{( 0 )} ( t ) = \{ \begin{matrix} = S k ( t + T - t ) , f o r t in [ 0 , t ] \\ 0 , o t h e r w i s e\end{matrix} \\ S {k}^{( 1 )} ( t ) = \{ \begin{matrix} = S k ( t - t ) , f o r t in [ t , T ] \\ 0 , o t h e r w i s e\end{matrix}$$

wherein Sₖ(t) is a FHSS signal having a duration of T; then outputs a plurality of linearly-modulated signals 1180 based on the above equation 1160.

If the FHSS signals are synchronous 1130, outputs the FHSS signals 1150 plurality of linearly-modulated signals 1180; correlating the received signal based on the following steps. FIG. 12 depicts the rationale of how to split the asynchronous signal into synchronous signals.

Please note that in FIG. 11, the step 1110 and the step 1130 are interchangeable, which means upon reception of the signals of the first and the second SS transmission scheme, we can determine if the signals are synchronous beforehand, and then determine if the signals are linearly-modulated. The ordering of step 1110 and 1130 in FIG. 11 has no significant importance.

Furthermore, in FIG. 13, calculate a combination coefficient 1310 using the timing information of the FHSS signals; use a FHSS signal in the plurality of linearly-modulated to produce a FHSS signal with time delay 1330, wherein the time delay is determined by received timings of the FHSS signals; correlates the received signal with the FHSS signal with time-delay 1340; generates linear combination outputs 1360 based on the output of step 1310 and 1340; and selectively produce an estimated information sequence carried by the FHSS signals based on the linear combination outputs 1360.

Still in another exemplar aspect of the present invention, in FIG. 11, a system of mitigating interference effects under a communication environment including a first spread spectrum (SS) transmission scheme and a second spread spectrum (SS) transmission scheme in the same frequency band is proposed, which comprises: an identification block 210 for outputting number of signals of the first SS transmission scheme, and number of signals of the second SS transmission scheme.

Preferrably, the first SS transmission scheme is Direct Sequence Spread Spectrum (DSSS), and the identification block 210 further identifies an employed spreading waveform of signals of DSSS in the received signal 200. The second SS transmission scheme is Frequency Hopping Spread Spectrum (FHSS), the identification block 210 further detects the hopping frequency of signals of FHSS in the received signal 200.

Also in this exemplar aspect of the invention, the system includes a synchronization block 220 for obtaining a timing information of signals of the first SS transmission scheme and the second SS transmission scheme; a construction block 240 for selectively generating a plurality linearly-modulated signals, further comprising a first block 1510 for producing a first plurality of linearly-modulated signals 1515 by constructing extra signals to the signals of the first and the second SS transmission scheme; and a second means for generating a plurality of linearly-modulated signals 245 using the first plurality of linearly-modulated signals 1515; and a detection block 270 for correlating the received signal 200 based on the plurality of linearly-modulated signals 245 to generate a correlated outputs; and selectively producing an estimated information sequence 280 carried by the signals of the first and the second SS transmission scheme based on the correlated outputs

Preferably, the construction block 240 also includes a third block 1530 for selectively performing the following equation:

$$s p l i t t i n g {S}_{k} ( t - τ ) i n t o {S}_{k} ( t - τ ) i n t o S {k}^{( 0 )} ( t ) = \{ \begin{matrix} = S k ( t + T - t ) , f o r t in [ 0 , t ] \\ 0 , o t h e r w i s e\end{matrix} \\ S {k}^{( 1 )} ( t ) = \{ \begin{matrix} = S k ( t - t ) , f o r t in [ t , T ] \\ 0 , o t h e r w i s e\end{matrix}$$

wherein Sₖ(t) is a signal of the first or the second SS transmission scheme in the first plurality of linearly-modulated signals having a duration of T; a fourth block 1540 for outputting a plurality of linearly-modulated signals 245 based on the above equation; and the first block 1510 further selectively outputs the first plurality of linearly-modulated signals as a plurality of linearly-modulated signals when the first plurality of linearly-modulated signals are synchronous.

FIG. 11 shows the detailed operation of the mechanism mentioned above, in step 1140, if the first plurality of linearly-modulated signals are asynchronous, performing the following equation 1170:

$$s p l i t t i n g {S}_{k} ( t - τ ) i n t o {S}_{k} ( t - τ ) i n t o S {k}^{( 0 )} ( t ) = \{ \begin{matrix} = S k ( t + T - t ) , f o r t in [ 0 , t ] \\ 0 , o t h e r w i s e\end{matrix} \\ S {k}^{( 1 )} ( t ) = \{ \begin{matrix} = S k ( t - t ) , f o r t in [ t , T ] \\ 0 , o t h e r w i s e\end{matrix}$$

wherein Sₖ(t) is a signal of the first or the second SS transmission scheme in the first plurality of linearly-modulated signals having a duration of T.

Afterwards, output a plurality of linearly-modulated signals 1180 based on the above equation 1170. If the first plurality of linearly-modulated signals are synchronous 1140, output the first plurality of linearly-modulated signals as a plurality of linearly-modulated signals 1180;

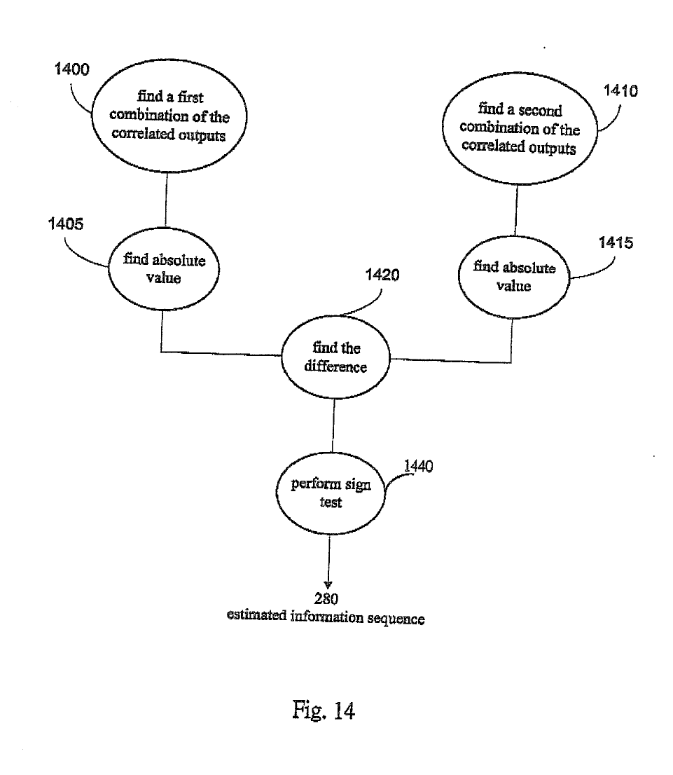

In FIG. 14, the detection means block 270 further selectively performs the following steps: finding a first linear combination of the correlated outputs using a combination coefficients 1140, wherein the combination coefficients are calculated using the timings of the signals of the first and the second SS transmission scheme; finding a second linear combination of the correlated outputs 1410 using the combination coefficients; finding a difference 1420, then the absolute value of difference between the first combination and the second combination of the correlated outputs; finally, performing sign test 1440 to the difference of absolute value to find the estimated information sequence 280.

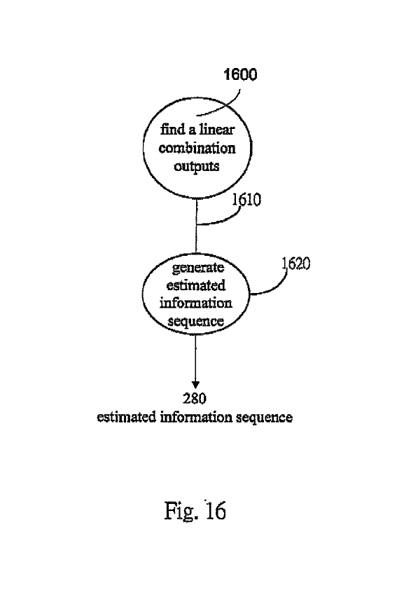

If a signal in the first and the second SS transmission scheme is linearly modulated, wherein the estimated information sequence is carried by the signal, the detection block 270 further selectively performs the following steps, as illustrated in FIG. 16: finding a linear combination of the correlated outputs 1610 using combination coefficients, wherein the combination coefficients are calculated using the timings of the signals of the first and second SS transmission scheme; in step 1620, selectively producing an estimated information sequence 280 carried by the signal by using the linear combination outputs 1610

And in another exemplar aspect of the invention, a system for mitigating interference effects under a communication environment including a first Direct Sequence Spread Spectrum (DSSS) signal and a second Direct Sequence Spread Spectrum (SS) signal coexisting in the same frequency band is propose. Please refer to FIG. 2, the system comprises an identification block 210 for outputting number and spreading waveform of the DSSS signals; a synchronization block 220 for obtaining a timing information of signal of the first DSSS signal and the second DSSS signal. The synchronization block 220 comprises a first block 910 (Please refer to FIG. 9) for obtaining the timing information of the first DSSS signal in the received signal when one signal of the first SS transmission scheme is detected before a predetermined time t1; and a second block 920 means for obtaining the timing information of the second DSSS signal in the received signal using the timing information of the first DSSS signal.

The system also includes a generation block 235 for generating a plurality of linearly-modulated signals; a detection block 270 for correlating the received signal based on the plurality of linearly-modulated signals to generate correlated outputs; and selectively producing an estimated information sequence 280 carried by the first DSSS signal and the second DSSS signal based on the correlated outputs.

This invention is applicable to various environments. For instance, in the DSSS signals co-existing environment mentioned above, it can be used to suppress the hostile and/or accidental sources of interference. Moreover, it can be used to mitigate the interference transmitted from other incompatible wireless communications systems which simultaneously utilize the same frequency band in a legal manner. For example, the IEEE 802.11b, the IEEE 802.15, HomeRF, and etc aim the unlicensed ISM (industrial-science-medical) band as their target band taking rules from FCC (federal communications commission). And the coexistence issue on how to mitigate the mutual interference from these incompatible but legal protocols becomes the most challenging task.

To better illustrate the present invention and the various embodiments, please refer to the appendix: “Linear Interference Suppression Detection to the FHSS and DSSS Coexistent Environment in the Same Frequency Band”, by the inventor, which is not disclosed yet. And the papers and patents cited are listed in the appendix.

In the foregoing specification the invention has been described with reference to specific exemplar aspects thereof. It will, however, be evident that various modification and changes may be made to thereto without departing from the broader spirit and scope of the invention. The specification and drawings are, accordingly, to be regarded in an illustrative rather than restrictive sense.

What is claimed is:

1. A method of mitigating interference effects under a communication environment including a first spread spectrum (SS) transmission scheme and a second spread spectrum (SS) transmission scheme in the same frequency band, comprising the steps of:
(1.1) responsive to received signal, outputting number of signals of the first SS transmission scheme, and outputting number of signals of the second SS transmission scheme;
(1.2) obtaining a timing information of signals of the first SS transmission scheme and the second SS transmission scheme, wherein
(1.2a) obtaining the timing information of signals of the first SS transmission scheme in the received signal when one signal of the first SS transmission scheme is detected before a predetermined time t1; and
(1.2b) obtaining the timing information of signals of the second SS transmission scheme in the received signal using the timing information of signals of the first SS transmission scheme.
(1.3) generating a plurality of linearly-modulated signals;
(1.4) correlating the received signal based on the plurality of linearly-modulated signals to generate correlated outputs; and
(1.5) selectively producing an estimated information sequence carried by the signals of the first SS transmission scheme and the signals of the second SS transmission scheme based on the correlated outputs.

2. The method of claim 1, wherein the first SS transmission scheme is Direct Sequence Spread Spectrum (DSSS).

3. The method of claim 2, wherein between the step (1.1) and the step (1.2) further comprises the steps of
identifying an employed spreading waveform of signals of DSSS in the received signal.

4. The method of claim 1, wherein the second SS transmission scheme is Frequency Hopping Spread Spectrum (FHSS).

5. The method of claim 4, wherein between the step (1.1) and step (1.2) further comprises the step of
detecting the hopping frequency of signals of FHSS in the received signal.

6. The method of claim 1, wherein, in the step (1.2), the step of obtaining the timing information of signals of second SS transmission scheme comprises the step of:
assuming the timing of signals of the second SS transmission scheme in the received signal equal to the timing of signals of the first SS transmission scheme.

7. The method of claim 6, further comprises the steps of:
(7.1) obtaining a phase information of signals of the first SS transmission scheme transmission scheme in the received signal; and
(7.2) obtaining a phase of signals of the second SS transmission scheme in the received signal using the timing information of signals of the first SS transmission scheme.

8. The method of claim 6, further comprises the steps of:
(8.1) obtaining an amplitude information of signals of the first SS transmission scheme in the received signal; and
(8.2) obtaining an amplitude information of signals of the second SS transmission scheme in the received signal using the timing information of signals of the first SS transmission scheme.

9. The method of claim 6, further comprises the steps of:
(9.1) selectively outputting a chosen signal with a time delay in the first and the second SS transmission scheme, wherein the time delay is determined by the timing information of the first and the second SS transmission scheme;
(9.2) calculating combination coefficients based on the timing information of the first and the second SS transmission scheme;
(9.3) correlating the received signal with the chosen signal to produce correlating outputs;
(9.4) linearly combining the correlating outputs using the combination coefficients;
(9.5) obtaining a phase and amplitude of the chosen signal using the linear combination output.

10. The method of claim 1, wherein the step (1.2) comprises the step of:
obtaining the timing information of signals of the second SS transmission scheme in the received signal when there is no signal of the first SS transmission scheme is detected after the predetermined time t1.

11. The method of claim 1, wherein between the step (1.2) and step (1.3) further comprises the step of:
obtaining a phase information of signals of the second SS transmission scheme in the received signal when there is no signal of the first SS transmission scheme is detected after the predetermined time t1.

12. The method of claim 1, wherein between the step (1.2) and step (1.3) further comprises the step of:
obtaining an amplitude information of signals of the second SS transmission scheme in the received signal when there is no signal of the first SS transmission scheme is detected after the predetermined time t1.

13. The method of claim 1, wherein between the step (1.2) and step (1.3) further comprises the step of:
(13.1) obtaining a phase information of signals of the first SS transmission scheme in the received signal when one signal of the first SS transmission scheme is detected before a predetermined time t1; and
(13.2) obtaining a phase information of signals of the second SS transmission scheme in the received signal using the timing information of signals of the first SS transmission scheme.

14. The method of claim 1, wherein between the step (1.2) and step (1.3) further comprises the step of:
(14.1) obtaining an amplitude information of signals of the first SS transmission scheme in the received signal when one signal of the first SS transmission scheme is detected before a predetermined time t1; and
(14.2) obtaining an amplitude information of signals of the second SS transmission scheme in the received signal using the timing information of signals of the first SS transmission scheme.

15. The method of claim 1, wherein between the step (1.2) and step (1.3) further comprises the step of:
(15.1) obtaining a phase and amplitude information of signals of the first SS transmission scheme in the received signal when one signal of the first SS transmission scheme is detected before a predetermined time t1; and
(15.2) obtaining the phase and amplitude information of signals of the second SS transmission scheme in the received signal using the timing, phase and amplitude information of signals of the first SS transmission scheme.

16. The method of claim 1, wherein the step (1.2) comprises the steps of:
(16.1) when one signal of the first SS transmission scheme in the received signal is detected after a predetermined time t2, peeking other frequency bands to obtain a first timing information of signals of the first SS transmission scheme in the received signal, wherein the other frequency bands refers to frequency bands that contain the signals of the first SS transmission scheme;
(16.2) when one signal of the first SS transmission scheme in the received signal is detected before the predetermined time t2, obtaining a second timing information of signals of the first SS transmission scheme in the received signal; and
(16.3) obtaining a timing information of signals of the second SS transmission scheme in the received signal using the first and the second timing information of the signals of the first SS transmission scheme.

17. The method of claim 13, wherein further comprises the steps of:
(17.1) when one signal of the first SS transmission scheme in the received signal is detected after a predetermined time t2, peeking other frequency bands to obtain a first timing and phase information of signals of the first SS transmission scheme in the received signal, wherein the other frequency bands refers to frequency bands that contain the signals of the first SS transmission scheme;
(17.2) when one signal of the first SS transmission scheme in the received signal is detected before the predetermined time t2, obtaining a second timing and phase information of signals of the first SS transmission scheme in the received signal; and
(17.3) obtaining the timing and phase information of signals of the second SS transmission scheme in the received signal using the first and the second timing and phase information of the signals of the first SS transmission scheme.

18. The method of claim 14, wherein further comprises the steps of:
(18.2) when one signal of the first SS transmission scheme in the received signal is detected after a predetermined time t2, peeking other frequency bands to obtain a first timing and amplitude information of signals of the first SS transmission scheme in the received signal, wherein the other frequency bands refers to frequency bands that contain the signals of the first SS transmission scheme;
(18.2) when one signal of the first SS transmission scheme in the received signal is detected before the predetermined time t2, obtaining a second timing and amplitude information of signals of the first SS transmission scheme in the received signal; and
(18.3) obtaining the timing and amplitude information of signals of the second SS transmission scheme in the received signal using the first and the second timing and amplitude information of the signals of the first SS transmission scheme.

19. The method of claim 15, wherein further comprises the steps of:
(19.1) when one signals of the first SS transmission scheme in the received signal is detected after a predetermined time t2, peeking other frequency bands to obtain a first timing, phase and amplitude information of signals of the first SS transmission scheme in the received signal, wherein the other frequency bands refers to frequency bands that contain the signals of the first SS transmission scheme;
(19.2) when one signal of the first SS transmission scheme in the received signal is detected before the predetermined time t2, obtaining a second timing, phase and amplitude information of signals of the first SS transmission scheme in the received signal; and
(19.3) obtaining the timing phase, and amplitude information of signals of the second SS transmission scheme in the received signal using the first and the second timing, phase and amplitude information of the signals of the first SS transmission scheme.

20. The method of claim 1 or 16, wherein the step of obtaining the timing information of signals of the second SS transmission scheme comprises the steps of:
200. performing the following steps for M times:
(200.1) assuming an initial received timing estimate τ of signals of the second SS transmission scheme in the received signal;
(200.2) calculating an intermediate timing of signals of the second SS transmission scheme in the received signal using the timing information of signals of the first SS transmission scheme in the received signal and the initial received timing estimation τ;
(200.3) obtaining an intermediate phase, amplitude of signals of the second SS transmission scheme in the received signal on the intermediate timing;
201. obtaining the timing, phase and amplitude information of signals of the second SS transmission scheme by averaging the intermediate timings, phases and amplitudes obtained in step 200 by M.

21. The method of claim 15 or 19, wherein the step of obtaining the timing, phase and amplitude information of signals of the second SS transmission scheme comprises the steps of:
210. performing the following steps for M times:
(210.1) assuming an initial received timing estimation τ of signals of the second SS transmission scheme in the received signal;
(210.2) calculating an intermediate timing of signals of the second SS transmission scheme in the received signal using the timing, phase and amplitude information of signals of the first SS transmission scheme in the received signal and the initial received timing estimation τ;
(210.3) obtaining an intermediate phase, amplitude of signals of the second SS transmission scheme in the received signal based on the intermediate timing;
211. obtaining the timing, phase and amplitude information of signals of the second SS transmission scheme by averaging the intermediate timings, phases and amplitudes obtained in step 210 by M.

22. A method of mitigating interference effects under a communication environment including a Direct Sequence Spread Spectrum (DSSS) signal and a Frequency Hopping Spread Spectrum (FHSS) signal in the same frequency band, comprising the steps of:
(22.1) responsive to a received signal, outputting number and spreading waveform of the DSSS signals, and outputting number and hopping frequencies of the FHSS signals;
(22.2) obtaining timings of the DSSS signals and the FHSS signals;
(22.3) if the DSSS signals and the FHSS signals are linearly-modulated, outputting a plurality of linearly-modulated signals based on a predetermined manner;
(22.4) correlating the received signal based on the following steps:
(22.4a) calculating a combination coefficient using the timing information of the FHSS signals and the DSSS signals;
(22.4b) correlating the received signal with DSSS signal;
(22.4c) using a FHSS signal in the plurality of linearly-modulated to produce a FHSS signal with time delay, wherein the time delay is determined by received timings of the FHSS signals.
(22.4d) correlating the received signal with the FHSS signal with time-delay.
(22.4e) generating linear combination outputs based on step (22.4a) step (22.4b) and step (2.4d); and
(22.5) selectively producing an estimated information sequence carried by the DSSS signals and the FHSS signals based on the linear combination outputs.

23. The method of claim 22, wherein the predetermined manner in the step (22.3) comprising:
(23.1) if the DSSS and FHSS signals are asynchronous, performing the following equation:
$$splitting {S}_{k} ( t - τ ) into {S}_{k} ( t - τ ) into {Sk}^{( 0 )} ( t ) = \{ \begin{matrix}= Sk ( t + T - t ) , for t in [ 0 , t ] \\ 0 , otherwise\end{matrix} \\ {Sk}^{( 1 )} ( t ) = \{ \begin{matrix}= Sk ( t - t ) , for t in [ t , T ] \\ 0 , otherwise\end{matrix}$$
wherein Sₖ(t) is a FHSS or DSSS signal having a duration of T;
(23.2) outputting a plurality of linearly-modulated signal based on the above equation;
(23.3) if the DSSS and the FHSS signals are synchronous, outputting the DSSS signals and the FHSS signals as a plurality of linearly-modulated signals;

24. A method of mitigating interference effects under a communication environment including a Frequency Hopping Spread Spectrum (FHSS) signal and a Frequency Hopping Spread Spectrum (FHSS) signal in the same frequency band, comprising the steps of:
(24.1) responsive to a received signal, outputting number and hopping frequencies of the FHSS signals;
(24.2) obtaining timings of the FHSS signals;
(24.3) if the FHSS signals are linearly-modulated, outputting a plurality of linearly-modulated signals based on a predetermined manner;
(24.4) correlating the received signal based on the following steps:
(23.4a) calculating a combination coefficient using the timing information of the FHSS signals;
(23.4b) using a FHSS signal in the plurality of linearly-modulated to produce a FHSS signal with time delay, wherein the time delay is determined by received timings of the FHSS signals.
(23.4c) correlating the received signal with the FHSS signal with time-delay.
(23.4d) generating linear combination outputs based on step (23.4a) and step (23.4c); and
(24.5) selectively producing an estimated information sequence carried by the DSSS signals and the FHSS signals based on the linear combination outputs.

25. The method of claim 24, wherein the predetermined manner in step (24.3) comprising:
(25.1) if the FHSS signals are asynchronous, performing the following equation:
$$splitting {S}_{k} ( t - τ ) into {S}_{k} ( t - τ ) into {Sk}^{( 0 )} ( t ) = \{ \begin{matrix}= Sk ( t + T - t ) , for t in [ 0 , t ] \\ 0 , otherwise\end{matrix} \\ {Sk}^{( 1 )} ( t ) = \{ \begin{matrix}= Sk ( t - t ) , for t in [ t , T ] \\ 0 , otherwise\end{matrix}$$
wherein Sₖ(t) is a FHSS signal having a duration of T;
(25.2) outputting a plurality of linearly-modulated signals based on the above equation;
(25.3) if the FHSS signals are synchronous, outputting the FHSS signals as a plurality of linearly-modulated signals;

26. A method of mitigating interference effects under a communication environment including a first spread spectrum (SS) transmission scheme and a second spread spectrum (SS) transmission scheme in the same frequency band, comprising the steps of:
(26.1) responsive to received signal, outputting number of signals of the first SS transmission scheme, and outputting number of signals of the second SS transmission scheme;
(26.2) obtaining a timing information of signals of the first SS transmission scheme and the second SS transmission scheme
(26.3) if a signal of the first SS transmission scheme and the second SS transmission scheme is non-linearly-modulated, wherein
(26.3a) producing a first plurality of linearly-modulated signals by constructing extra signals to the signals of the first and the second SS transmission scheme; and
(26.3a) generating a plurality of linearly-modulated signals using the first plurality of linearly-modulated signals in a predetermined manner.
(26.4) correlating the received signal based on the plurality of linearly-modulated signals to generate a correlated outputs; and
(26.5) selectively producing a estimated information sequence carried by the signals of the first and the second SS transmission scheme based on the correlated outputs.

27. The method of claim 26, wherein the first SS transmission scheme is Direct Sequence Spread Spectrum (DSSS).

28. The method of claim 27, wherein between the step (26.1) and the step (26.2) further comprises the step of
identifying an employed spreading waveform of signals of DSSS in the received signal.

29. The method of claim 26, wherein the second SS transmission scheme is Frequency Hopping Spread Spectrum (FHSS).

30. The Method of claim 29, wherein between the step (26.1) and step (26.2) further comprises the step of
detecting the hopping frequency of signals of FHSS in the received signal.

31. The method of claim 26, wherein the predetermined step in (26.3) comprising:
(31.1) if the first plurality of linearly-modulated signals are asynchronous, performing the following equation:
$$splitting {S}_{k} ( t - τ ) into {S}_{k} ( t - τ ) into {Sk}^{( 0 )} ( t ) = \{ \begin{matrix}= Sk ( t + T - t ) , for t in [ 0 , t ] \\ 0 , otherwise\end{matrix} \\ {Sk}^{( 1 )} ( t ) = \{ \begin{matrix}= Sk ( t - t ) , for t in [ t , T ] \\ 0 , otherwise\end{matrix}$$
wherein Sₖ(t) is a signal of the first or the second SS transmission scheme in the first plurality of linearly-modulated signals having a duration of T;
(31.2) outputting a plurality of linearly-modulated signal based on the above equation;
(31.3) if the first plurality of linearly-modulated signals are synchronous, outputting the first plurality of linearly-modulated signals as a plurality of linearly-modulated signals;

32. The method of claim 26, wherein the step (26.5) comprising:
if a signal in the first and the second SS transmission scheme is non-linearly-modulated, wherein the estimated information sequence is carried by the signal, performing the following steps:
(32.1) finding a first linear combination of the correlated outputs using a combination coefficients, wherein the combination coefficients are calculated using the timings of the signals of the first and the second SS transmission scheme;
(32.2) finding a second linear combination of the correlated outputs using the combination coefficients;
(32.3) finding a difference of absolute value between the first combination and the second combination of the correlated outputs; and
(32.4) performing sign test to the difference of absolute value.

33. A method of mitigating interference effects under a communication environment including a first Direct Sequence Spread Spectrum (DSSS) signal and a second Direct Sequence Spread Spectrum (SS) signal coexisting in the same frequency band, comprising the steps of:
(33.1) responsive to received signal outputting number and spreading waveform of the DSSS signals;
(33.2) obtaining a timing information of signal of the first DSSS signal and the second DSSS signal, wherein
(33.2a) obtaining the timing information of the first DSSS signal in the received signal when one signal of the first SS transmission scheme is detected before a predetermined time t1; and
(33.2b) obtaining the timing information of the second DSSS signal in the received signal using the timing information of the first DSSS signal.
(33.3) generating a plurality of linearly-modulated signals;
(33.4) correlating the received signal based on the plurality of linearly-modulated signals to generate correlated outputs; and
(33.5) selectively producing an estimated information sequence carried by the first DSSS signal and the second DSSS signal based on the correlated outputs.

34. A system for mitigating interference effects under a communication environment including a first spread spectrum (SS) transmission scheme and a second spread spectrum (SS) transmission scheme in the same frequency band, comprising:
an identification means, responsive to received signal, for outputting number of signals of the first SS transmission scheme, and outputting number of signals of the second SS transmission scheme;
a synchronization means for obtaining a timing information of signals of the first SS transmission scheme and the second SS transmission scheme, comprising
a first means for obtaining the timing information of signals of the first SS transmission scheme in the received signal when one signal of the first SS transmission scheme is detected before a predetermined time t1; and
a second means for obtaining the timing information of signals of the second SS transmission scheme in the received signal using the timing information of signals of the first SS transmission scheme;
a generation means for generating a plurality of linearly-modulated signals;
a detection means for correlating the received signal based on the plurality of linearly-modulated signals to generate correlated outputs and selectively producing an estimated information sequence carried by the signals of the first SS transmission scheme and the signals of the second SS transmission scheme based on the correlated outputs.

35. The system of claim 34, wherein the first SS transmission scheme is Direct Sequence Spread Spectrum (DSSS).

36. The system of claim 35, wherein the identification means further identifies an employed spreading waveform of signals of DSSS in the received signal.

37. The system of claim 34, wherein the second SS transmission scheme is Frequency Hopping Spread Spectrum (FHSS).

38. The system of claim 37, wherein the identification means further detects the hopping frequency of signals of FHSS in the received signal.

39. The system of claim 34, wherein the synchronization means comprises:
a third means for assuming the timing of signals of the second SS transmission scheme in the received signal equal to the timing of signals of the first SS transmission scheme.

40. The system of claim 39, wherein,
the first means further obtains a phase information of signals of the first SS transmission scheme transmission scheme in the received signal; and
the second means further obtains a phase of signals of the second SS transmission scheme in the received signal using the timing information of signals of the first SS transmission scheme.

41. The system of claim 39, wherein,
the first means further obtains an amplitude information of signals of the first SS transmission scheme in the received signal; and
the second means further obtains an amplitude information of signals of the second SS transmission scheme in the received signal using the timing information of signals of the first SS transmission scheme.

42. The system of claim 39, wherein the synchronization means further comprises:
a fourth means for selectively outputting a chosen signal with a time delay in the first and the second SS transmission scheme, wherein the time delay is determined by the timing information of the first and the second SS transmission scheme;
a fifth means for calculating combination coefficients based on the timing information of the first and the second SS transmission scheme;
a sixth means for correlating the received signal with the chosen signal to produce correlating outputs;
a seventh means for linearly combining the correlating outputs using the combination coefficients;
an eighth means for obtaining a phase and amplitude of the chosen signal using the linear combination output.

43. The system of claim 34, wherein the second means further obtains the timing information of signals of the second SS transmission scheme in the received signal when there is no signal of the first SS transmission scheme is detected after the predetermined time t1.

44. The system of claim 34, where the second mean further obtains a phase information of signals of the second SS transmission scheme in the received signal when there is no signal of the first SS transmission scheme is detected after the predetermined time t1.

45. The system of claim 34, wherein the second means further obtains an amplitude information of signals of the second SS transmission scheme in the received signal when there is no signal of the first SS transmission scheme is detected after the predetermined time t1.

46. The system of claim 34, wherein the first means further obtains a phase information of signals of the first SS transmission scheme in the received signal when one signal of the first SS transmission scheme is detected before a predetermined time t1; and
the second means further obtains a phase information of signals of the second SS transmission scheme in the received signal using the timing information of signals of the first SS transmission scheme.

47. The system of claim 34, wherein the first means further selectively obtains an amplitude information of signals of the first SS transmission scheme in the received signal;
the second means further selectively obtains an amplitude information of signals of the second SS transmission scheme in the received signal using the timing information of signals of the first SS transmission scheme.

48. The system of claim 34, wherein the first means further selectively obtains a phase and amplitude information of signals of the first SS transmission scheme in the received signal;
the second means further obtains the phase and amplitude information of signals of the second SS transmission scheme in the received signal using the timing, phase and amplitude information of signals of the first SS transmission scheme.

49. The system of claim 34, wherein the first means further selectively peeking other frequency bands to obtain a first timing information of signals of the first SS transmission scheme in the received signal; and further selectively obtains a second timing information of signals of the first SS transmission scheme in the received signal;
the second means further selectively obtains a timing information of signals of the second SS transmission scheme in the received signal using the first and the second timing information of the signals of the first SS transmission scheme.

50. The system of claim 34, wherein the first means further selectively peeks other frequency bands to obtain a first timing and phase information of signals of the first SS transmission scheme in the received signal; and further selectively obtains a second timing and phase information of signals of the first SS transmission scheme in the received signal;
the second means further obtains the timing and phase information of signals of the second SS transmission scheme in the received signal using the first and the second timing and phase information of the signals of the first SS transmission scheme.

51. The system of claim 34, wherein the first means further selectively peeks other frequency bands to obtain a first timing and amplitude information of signals of the first SS transmission scheme in the received signal; and further selectively obtains a second timing and amplitude information of signals of the first SS transmission scheme in the received signal;
the second means further selectively obtains the timing and amplitude information of signals of the second SS transmission scheme in the received signal using the first and the second timing and amplitude information of the signals of the first SS transmission scheme.

52. The system of claim 34, wherein the first means further selectively peeks other frequency bands to obtain a first timing, phase and amplitude information of signals of the first SS transmission scheme in the received signal; and further selectively obtains a second timing, phase and amplitude information of signals of the first SS transmission scheme in the received signal;
the second means further selectively obtaining the timing phase, and amplitude information of signals of the second SS transmission transmission scheme in the received signal using the first and the second timing, phase and amplitude information of the signals of the first SS transmission scheme.

53. The system of claim 34, wherein the second means comprises
a repeating means for performing the following steps for M times:
(530.1) assuming an initial received timing estimate τ of signals of the second SS transmission scheme in the received signal;
(530.2) calculating an intermediate timing of signals of the second SS transmission scheme in the received signal using the timing information of signals of the SS transmission scheme in the received signal and the initial received timing estimation τ;
(530.3) obtaining an intermediate phase, amplitude of signals of the second SS transmission scheme in the received signal based on the intermediate timing; and
an averaging means for obtaining the timing, phase and amplitude information of signals of the second SS transmission scheme by averaging the intermediate timings, phases and amplitudes obtained in the repeating means by M.

54. A system for mitigating interference effects under a communication environment including a Direct Sequence Spread Spectrum (DSSS) signal and a Frequency Hopping Spread Spectrum (FHSS) signal in the same frequency band, comprising:
an identification means, responsive to a received signal, for outputting number and spreading waveform of the DSSS signals, and outputting number and hopping frequencies of the FHSS signals;
a synchronous means for obtaining timings of the DSSS signals and the FHSS signals;
a construction means for selectively outputting a plurality of linearly-modulated signals;
a calculation means for calculating combination coefficients using the timing information of the DSSS signal and the FHSS signal;
a detection means for correlating the received signal, comprising:
a first means for correlating the received signal with DSSS signal;
a second means for using a FHSS signal in the plurality of linearly-modulated to produce a FHSS signal with time delay, wherein the time delay is determined by received timings of the FHSS signals.
a third means for correlating the received signal with the FHSS signal with time-delay.
a fourth means for generating linear combination outputs;
a fifth means for selectively producing an estimated information sequence carried by the DSSS signals and the FHSS signals based on the linear combination outputs.

55. The system of claim 54, wherein the construction means comprises:
a first means for selectively performing the following equation:
$$splitting {S}_{k} ( t - τ ) into {S}_{k} ( t - τ ) into {Sk}^{( 0 )} ( t ) = \{ \begin{matrix}= Sk ( t + T - t ) , for t in [ 0 , t ] \\ 0 , otherwise\end{matrix} \\ {Sk}^{( 1 )} ( t ) = \{ \begin{matrix}= Sk ( t - t ) , for t in [ t , T ] \\ 0 , otherwise\end{matrix}$$
wherein Sₖ(t) is a FHSS or DSSS signal having a duration of T;
a second means for outputting a plurality of linearly-modulated signals;
a third means for selectively outputting the DSSS signals and the FHSS signals as a plurality of linearly-modulated signals;

56. A system of mitigating interference effects under a communication environment including a Frequency Hopping Spread Spectrum (FHSS) signal and a Frequency Hopping Spread Spectrum (FHSS) signal in the same frequency band, comprising:
an identification means, responsive to a received signal, for outputting number and hopping frequencies of the FHSS signals;
a synchronization means for obtaining timings of the FHSS signals;
a construction means for selectively outputting a plurality of linearly-modulated signals;
a calculating means for calculating a combination coefficient using the timing information of the FHSS signals;
a detection means for correlating the received signal, comprising:
a first means for using a FHSS signal in the plurality of linearly-modulated to produce a FHSS signal with time delay, wherein the time delay is determined by received timings of the FHSS signals;
a second means for correlating the received signal with the FHSS signal with time-delay;
a third means for generating linear combination outputs;
a fourth means for selectively producing an estimated information sequence carried by the DSSS signals and the FHSS signals based on the linear combination outputs.

57. The method of claim 56, wherein the construction means comprising:
a first means for selectively performing the following equation:
$$splitting {S}_{k} ( t - τ ) into {S}_{k} ( t - τ ) into {Sk}^{( 0 )} ( t ) = \{ \begin{matrix}= Sk ( t + T - t ) , for t in [ 0 , t ] \\ 0 , otherwise\end{matrix} \\ {Sk}^{( 1 )} ( t ) = \{ \begin{matrix}= Sk ( t - t ) , for t in [ t , T ] \\ 0 , otherwise\end{matrix}$$
wherein Sₖ(t) is a FHSS signal having a duration of T;
a second means for outputting a plurality of linearly-modulated signals based on the above equation;
a third means for selectively outputting the FHSS signals as a plurality of linearly-modulated signals;

58. A system of mitigating interference effects under a communication environment including a first spread spectrum (SS) transmission scheme and a second spread spectrum (SS) transmission scheme in the same frequency band, comprising:
an identification means, responsive to received signal, for outputting number of signals of the first SS transmission scheme, and outputting number of signals of the second SS transmission scheme;
a synchronization means for obtaining a timing information of signals of the first SS transmission scheme and the second SS transmission scheme
a construction means for selectively generating a plurality linearly-modulated signals, comprising
a first means for producing a first plurality of linearly-modulated signals by constructing extra signals to the signals of the first and the second SS transmission scheme; and
a second means for generating a plurality of linearly-modulated signals using the first plurality of linearly-modulated signals; and
a detection means for correlating the received signal based on the plurality of linearly-modulated signals to generate a correlated outputs; and selectively producing an estimated information sequence carried by the signals of the first and the second SS transmission scheme based on the correlated outputs

59. The system of claim 58, wherein the first SS transmission scheme is Direct Sequence Spread Spectrum (DSSS).

60. The system of claim 58, wherein the identification means further identifies an employed spreading waveform of signals of DSSS in the received signal.

61. The system of claim 58, wherein the second SS transmission scheme is Frequency Hopping Spread Spectrum (FHSS).

62. The system of claim 61, wherein the identification means further detects the hopping frequency of signals of FHSS in the received signal.

63. The method of claim 58, wherein the construction means comprises;
a third means for selectively performing the following equation:
$$splitting {S}_{k} ( t - τ ) into {S}_{k} ( t - τ ) into {Sk}^{( 0 )} ( t ) = \{ \begin{matrix}= Sk ( t + T - t ) , for t in [ 0 , t ] \\ 0 , otherwise\end{matrix} \\ {Sk}^{( 1 )} ( t ) = \{ \begin{matrix}= Sk ( t - t ) , for t in [ t , T ] \\ 0 , otherwise\end{matrix}$$
wherein Sₖ(t) is a signal of the first or the second SS transmission scheme in the first plurality of linearly-modulated signals having a duration of T;
a fourth means for outputting a plurality of linearly-modulated signals based on the above equation;
the first means for firer selectively outputting the first plurality of linearly-modulated signals as a plurality of linearly-modulated signals;

64. The system of claim 58, wherein the detection means further selectively performs the following steps:
(64.1) finding a linear combination of the correlated outputs using a combination coefficients, wherein the combination coefficients are calculated using the timings of the signals of the first and the second SS transmission scheme;
(64.2) finding a second linear combination of the correlated outputs using the combination coefficients;
(64.3) finding a difference of absolute value between the first combination and the second combination of the correlated outputs; and
(64.4) performing sign test to the difference of absolute value.

65. The system of claim 58, wherein the detection means further selectively performs the following steps:
(65.1) finding a linear combination of the correlated outputs using combination coefficients, wherein the combination coefficients are calculated using the timings of the signals of the first and second SS transmission scheme; and
(65.2) selectively producing an estimated information sequence carried by the signal by using the linear combination outputs.

66. A system for mitigating interference effects under a communication environment including a first Direct Sequence Spread Spectrum (DSSS) signal and a second Direct Sequence Spread Spectrum (SS) signal coexisting in the same frequency band, comprising:
an identification means, responsive to received signal, for outputting number and spreading waveform of the DSSS signals;
a synchronization means for obtaining a timing information of signal of the first DSSS signal and the second DSSS signal, comprising
a first means for obtaining the timing information of the first DSSS signal in the received signal when one signal of the first SS transmission scheme is detected before a predetermined time t1; and
a second means for obtaining the timing information of the second DSSS signal in the received signal using the timing information of the first DSSS signal.
a generation means for generating a plurality of linearly-modulated signals;
a detection means for correlating the received signal based on the plurality of linearly-modulated signals to generate correlated outputs; and selectively producing an estimated information sequence carried by the first DSSS signal and the second DSSS signal based on the correlated outputs.

67. The method of claim 26, wherein the step (26.5) comprising:
if a signal in the first and the second SS transmission scheme is linearly modulated, wherein the estimated information sequence is carried by the signal, performing the following steps:
(67.1) finding a linear combination of the correlated outputs using combination coefficients, when the combination coefficients are calculated using the timings of the signals of the first and second SS transmission scheme;
(67.2) selectively producing an estimated information sequence carried by the signal by using the linear combination outputs.
